(19) United States
(12) Patent Application Publication
(10) Pub. No.: US 2002/0058136 A1
(43) Pub. Date: May 16, 2002

(54) Powder injection molding process and apparatus

(75) Inventor: Hakim Belhadjhamida, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Mold-Masters Limited

(21) Appl. No.: 09/931,272

(22) Filed: Aug. 17, 2001

Related U.S. Application Data
(60) Provisional application No. 60/225,749, filed on Aug. 17, 2000.

(51) Int. Cl. B32B 3/26; B29C 67/04; B29C 67/20

(52) U.S. Cl. 428/312.2; 264/44; 264/50; 264/645; 264/669; 264/572; 425/4 C

(57) ABSTRACT

A powder injection molding process involves providing a melt mixture that includes a powder and a binder. The melt mixture is pressurized in an injection molding machine and a gas is injected into the melt mixture. The melt mixture and gas are injected into at least one mold to form a green part and the binder is removed from the green part.

### CROSS-REFERENCE TO TRELATED APPLICATIONS

This application claims benefit from U.S. provisional application Serial No. 60/225,749 filed Aug. 17, 2000 which is incorporated herein by reference in its entirety.

### FIELD OF THE INVENTION

The present invention relates to the forming of metal or ceramic parts by powder injection molding and, more particularly, to the creation of open porosity for debinding “green” parts using a gas.

### BACKGROUND OF THE INVENTION

Powder injection molding is a process well-known in the art as useful in the forming of intricate metal and ceramic parts. Almost any metal or ceramic that can be reduced to a micron-sized, fine powder can be processed in this manner. In the process, an ultra-fine powder of a suitable metal or ceramic is blended with two materials, namely a “binder” and a “carrier”. The binder is typically a mixture of organic compounds, such as a synthetic polymer, which primarily acts as a temporary adhesive to assist holding the powder together during the intermediate stages of the process, though the binder material may also act as a lubricant during injection. The carrier, such as a wax, assists in lubrication and ultimately permits the binder to be removed from the part (in a manner described below) during post-molding heat treating, in a step typically referred to as “debinding”. The binder+carrier mixture may also variously contain other additives, such as surfactants, added to modify the properties of the overall mixture.

In a typical powder injection molding process, the powdered material, binder and carrier are added together and mixed in an extruding machine to create a “feedstock” mixture (see FIG. 1). The feedstock, which is typically pelletized after mixing, is then provided to an injection molding machine for heating to a flowable liquid state, known as the “melt”. The injection molding machine then injects the heated melt, under high pressure, to a mold to form a part in a manner essentially identical to the injection molding of plastics. Once molded, a “green” part is achieved and then cooled. The green part comprises three phases, namely powdered material, binder and carrier.

The green part is then subjected to a debinding step in which the earner is removed. Depending on the type of carrier and binder used, debinding may be accomplished by any number of carefully controlled means, including thermal, catalytic, or solvent extraction, or a combination thereof. Using a thermal method, by way of example, a low heat is applied to melt the carrier (but not the binder) from the green part, thus leaving behind a network of interconnected porosity within the part. Once the carrier is removed, the part is subjected to a higher heat which causes the binder material to melt and thereby escape from the part via the interconnected porosity, leaving the part substantially binder-free. Once the part has been fully debinded, depending on the requirements of the final part, additional sintering or heat treatment can be applied to the part to remove, in varying degrees, the porosity of the part to yield the final powder injection molded part.

In an improvement to the powder injection molding process, known commercially as POWDERFLO™ and described in U.S. Pat. Nos. 4,734,237, 5,250,251 and 5,397,520, a water-based binder system is used. In this process, the powdered material is mixed with water and a gelling agent, such as agar, to form a melt which is then injected in the mold (see FIG. 2). In this process, the water acts as a carrier and the agar acts a binder. The mixture is injection molded at low heat and low pressure to form a green part. The green part is then heated at low temperature to dry the part and thus extract the water. The space that was occupied by the water becomes channels of interconnected porosity that allows the rest of the binder to be removed during a subsequent heat treatment similar to that used in the prior art and described above.

Both processes, therefore, have a common approach of using a binder and carrier, which requires the carrier to first be extracted to create an interconnected porosity to permit the binder to be extracted. Clearly, however, it would be advantageous to eliminate steps in the powder injection molding process and therefore decrease the overall cycle time.

### SUMMARY OF THE INVENTION

According to the present invention, a powdered metal is mixed with a binder and provided to an injection molding machine, where it is processed into a heated melt. A gas is added under pressure to the heated melt and mixed therein. The melt+gas mixture is then injected into the mold. The gas forms a fine porosity in the molded part and, when the mold is opened, the porosity is cleared of the gas automatically as the mold is depressurized. The binder can then be removed immediately after the molding stage, by a typical sintering step. The use of the gas removes the need for a carrier and, thus, a separate, carrier-removing debinding step is not required.

### BRIEF DESCRIPTION OF THE DRAWINGS

FIG. 1 is a schematic representation of a powder injection molding process according to the prior art.

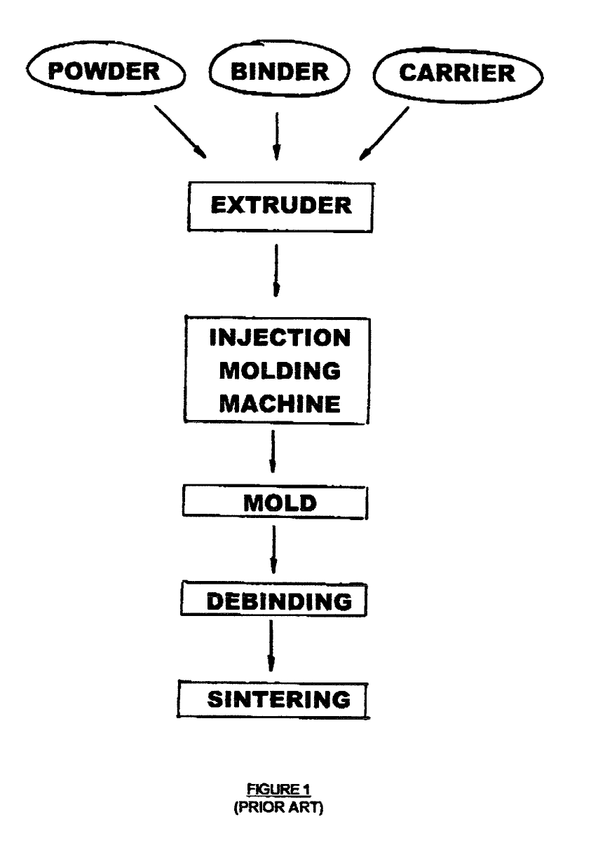

FIG. 2 is a schematic representation of a powder injection molding process according to the prior art, employing a water-based binder.

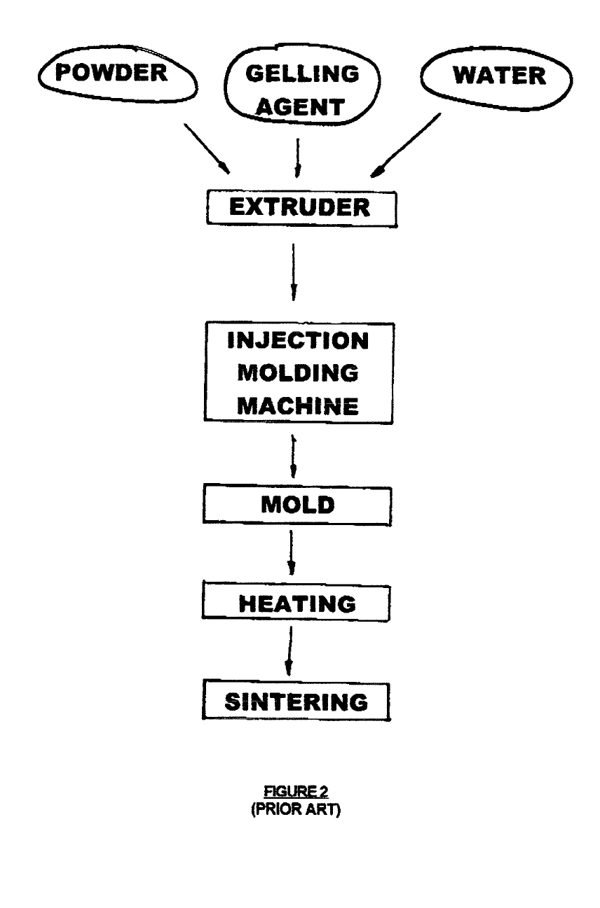

FIG. 3 is a schematic representation of a powder injection molding process according to the present invention.

FIG. 4 is a cross-sectional view of a green part formed according to the process of the present invention

FIG. 5 is a schematic representation of an apparatus for performing the powder injection molding process of the present invention.

FIG. 6 shows an embodiment of the current invention.

### DETAILED DESCRIPTION OF THE PRFERRED EMMODIMENT

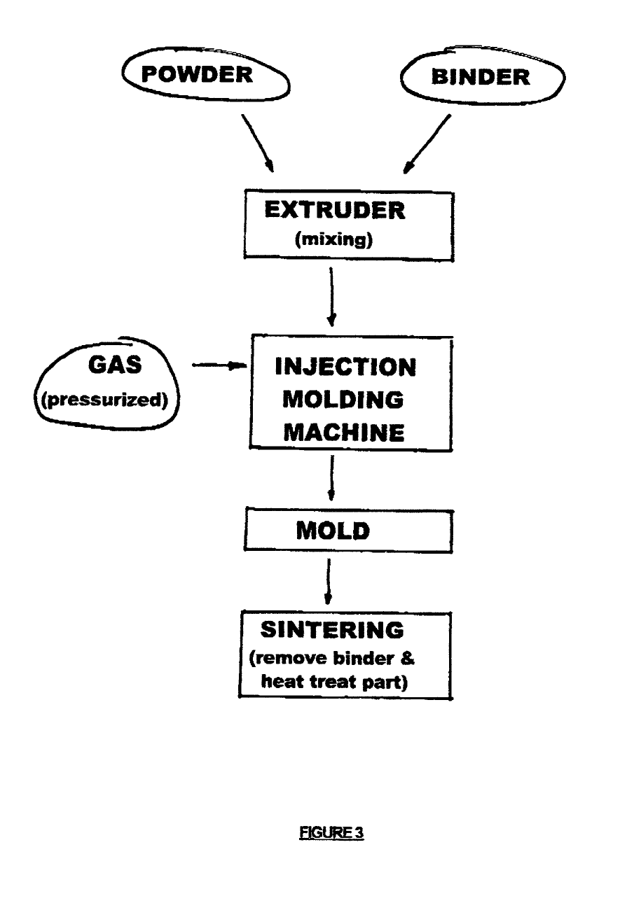

Referring to FIG. 3, in the present invention a powdered material, such as a metal or ceramic, is combined only with a suitable binder, preferably a polymer such as polypropylene, in an extruder machine or other known mixing means where it is mixed together by any manner known in the art to create a two material feedstock of powder+binder According to the current invention no carrier is added to the feedstock at this stage.

The feedstock is then provided from the extruder to an injection molding machine, where it is processed, typically by heating and/or mechanically working the feedstock, into a melted state, as is known in the art. According to the present invention, a pressurized gas is then introduced to the pressurized melt in the molding machine, where it mixes with and becomes included in the melt, resulting in a melt+gas mixture having a certain porosity, depending on the amount and pressure of the gas provided, as will be described below. The mixture is mixed until the gas and melt are distributed in substantially even proportions throughout the mixture, with the gas forming a series of connected bubbles or pores throughout the melt. The melt+gas mixture is then injected into a mold under high pressure.

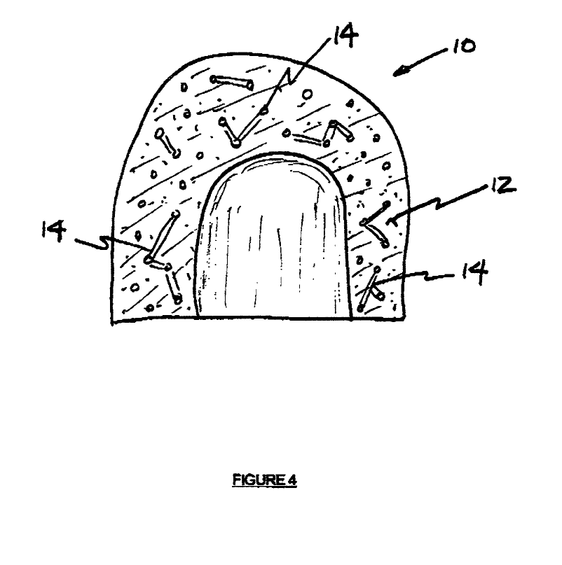

Immediately after molding (i.e. at while still at molding temperature and pressure), the green part has three phases, namely a powdered metal (or ceramic) phase, a liquid binder phase and a gas phase. As the part is cooled after molding, the powder and binder solidify (or semi-solidify), causing the included gas to create a network of interconnected porosity throughout the green part. When the mold is subsequently opened to remove the green part, the mold (and thus, the part) depressurizes permitting the gas to escape automatically from the interconnected porosity, thereby evacuating the part of the gas. (One will appreciate, however, that the porosity will still contain at least atmospheric air or the injected gas at roughly atmospheric pressure, or both). At this stage, the part appears substantially as shown in FIG. 4, with the green part 10 comprising a powder+binder substrate 12 and a network of interconnected porosity 14. (One skilled in the art will understand that the network of porosity 14 is in fact micro-porosity and would not ordinarily be immediately visible to the unskilled, naked eye, as it is depicted in FIG. 4).

With the gas substantially gone, the binder can then be extracted from the green part through the interconnected porosity in any manner known in the art. Preferably the binder is removed by means of controllably heating the green part in a furnace.

The gas is preferably nitrogen (N2) or carbon dioxide (CO2), or a combination thereof, and is provided in a pressurized state to the melt. Other gases known in the art as suitable for the disclosed process may alternately be used. Still alternately, a supercritical fluid (SCF) of an atmospheric gas may be applied to the melt to create porosity. There is different process that uses a gas to create porosity in a melt of a plastic material, known commercially as MUCELL™, described in U.S. Pat. Nos. 4,473,665, 5,158,986, 5,334,356 and 5,670,102, all of which are incorporated herein by reference. The MuCell process is only used to create pores in a final plastic product in order to increase the strength of the part and to reduce the pressure and the temperature of the melt during the injection process. The MuCell process has not been developed, tested or used in the powder injection molding process. The MuCell process has been developed, tested or used to create pores in a feedstock material in order to eliminate the de-binding step.

The choice of gas, its pressure, the volume supplied and the means and method of supplying the gas to the melt will affect the saturation of the gas in the melt, as will the nature of the powdered material and the binder chosen. These factors can be manipulated by one skilled in the art, in light of the disclosure herein, to permit the amount and size of pores created by the present process in the green part to be satisfactorily controlled to provide suitable results.

As will be understood by one skilled in the art, a sufficient quantity of gas must be added to the melt to saturate the mixture and thus permit the porosity in the green part to be substantially interconnected throughout the part. Such interconnected porosity is necessary to permit the binder to be substantially completely extracted from the part. As one skilled in the art will understand, a porosity of preferably about 20% (by volume) should be achieved, though a porosity percentage within a range on either side of this amount would be sufficient to permit the binder to be adequately removed, given the particular circumstances of the molding operation, metal, ceramic and/or binder materials employed, etc. Preferably a minimum of 10% is achieved and, more preferably, a minimum of 20% porosity is achieved.

Small amounts of the gas may remain trapped in the green part upon depressurization of the mold (i.e. in areas not communicating with the interconnected porosity), however, during the subsequent sintering step, as the binder material melts, additional porosity will be created in the part which may aid in extracting not only the binder material but remaining gas as well.

In the preferred embodiment, the gas is introduced under pressure to the molding machine for mixing with the powder+binder mixture, however the gas may alternately be introduced at other stages of the molding operation, such as in the runner system or in the mold cavity itself. The gas must be introduced under pressure to permit sufficient volumes of the gas to mix with the heated melt to yield the desired porosity.

The present invention may be used with single and multi-cavity molding operations.

One skilled in the art will understand that the feedstock prepared as described above can be immediately supplied to the molding machine after preparation, or may optionally be stored, preferably in a sealed condition, for use at a later time.

The process of the present invention can be applied to powdered injection molding where a binder is used to shape the part and is then extracted in a subsequent process. The powdered material may be any metal or ceramic known to useful in powder injection molding and the binder may be a polymer or a combination of polymers, together with any desired additives used to ease the mixing process, etc., as is well known in the art. As stated above, a polymer binder is preferred, though other known binders may be used to advantage.

The advantage of the present process is that it decreases cycle times by eliminating the debinding cycle from the powder injection molding process. This step is eliminated because the gas substantially exits the part automatically upon depressurization. Also, premixing is simpler as the process only requires two constituents to be mixed in the extruder. As the debinding operation (ie. the application of low heat to remove the carrier agent) in the prior is somewhat time consuming, the overall benefit in terms of decreased cycle time achievable with the present invention will be readily apparent.

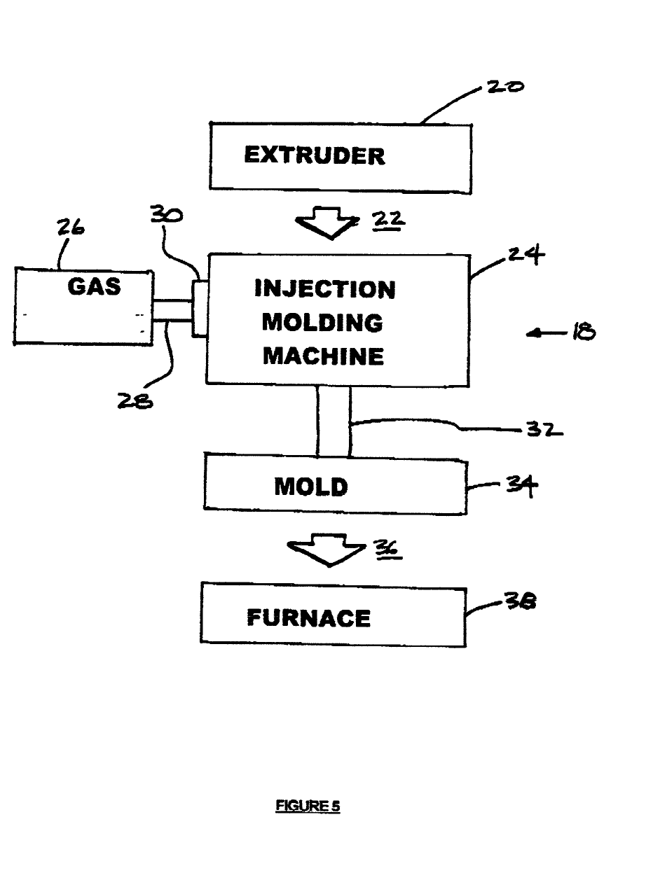

The present invention may be practised with the powder injection molding apparatus shown generally at 18 in FIG. 5. A mixer 20, such as an extruder, is provided for combining the powder and binder components into a feedstock. The feedstock is then delivered by any suitable means 22 to an injection molding machine 24, where it is processed into melt form. The melt is supplied with a pressurized gas, from a gas source 26 and gas transport member 28, such as a pipe, through a gas supply inlet 30 to machine 24 The injection molding machine 24 assists in thoroughly mixing the gas with the melt. Injection molding machine 24 then supplies the heated melt+gas mixture under pressure, via a runner system 32, to a standard cooled mold system 34, where mold system 34 is either a single- or multi-cavity mold or molds Mold system 34 may be cooled by any known means. After molding, the molded parts are then transferred, by any known means 36, to a heating device 38, such as a vacuum furnace, for removing the binder from the parts.

Gas supply inlet 30 may provide the gas locally to the injection molding machine, or may provide the gas at a plurality of locations through the use of a supply inlet 30 incorporating a supply manifold. Gas may be supplied by a plurality of sources and may be supplied at more than one location in apparatus 18, and need not necessarily be supplied to injection molding machine 24, though this is the preferred location.

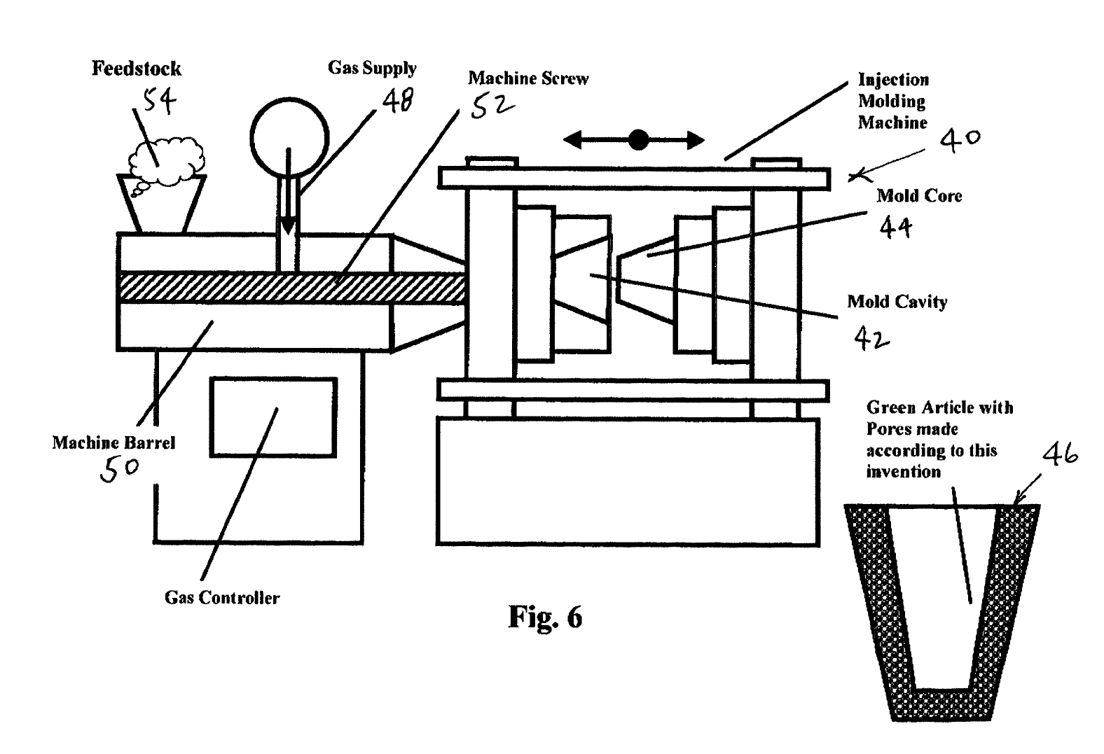

FIG. 6 shows an embodiment of the current invention where an injection molding machine 40 that includes a mold cavity plate 42 and a mold core plate 44 are used to form a mold cavity on the shape of the powder article 46 to be made.

A gas is introduced via a gas supply device 48 in the machine barrel 50 that uses a screw 52 to mix the feedstock 54 and the gas. The melt of the feedstock and gas is injected into the mold. The molded green part is later de-bound using the pores created by the gas to eliminate the binder.

While the above description discloses the preferred embodiments, it will be appreciated that the present invention is susceptible to modification and change without departing from the fair meaning of the proper scope of the invention herein disclosed.

I CLAIM:

1. An injection molding process comprising the steps of:
(a) providing a melt mixture including a powder and a binder,
(b) pressurizing said melt mixture in an injection molding machine;
(c) injecting a gas into said melt mixture;
(d) injecting said melt mixture and said gas into at least one mold to form a green part; and,
(e) removing said binder from said green part.

2. The process of claim 1 wherein said powder is selected from the group consisting of metal and ceramics.

3. The process of claim 1 wherein said binder consists of an organic polymer.

4. The process of claim 1 wherein said green part has a porosity of at least 10% by volume.

5. The process of claim 4 wherein said green part has a porosity of 20% by volume.

6. The process of claim 1 wherein said gas is injected into said melt mixture while said melt mixture is in said injection molding machine.

7. The process of claim 3 wherein said binder is removed from said green part by heating said green part.

8. The process of claim 1 wherein said gas is selected from the group consisting of nitrogen, carbon dioxide and supercritical fluids of atmospheric gases.

9. In an injection molding machine having a barrel, said barrel having a nozzle opening at one end, a feedstock hopper in fluid communication with the interior of said barrel and spaced from said nozzle opening, a heater for heating feedstock in said barrel into a melt, and injection means for injecting melt from said barrel said nozzle, the improvement comprising:
at least one orifice in said barrel connectable to a source of pressurized gas so that gas is injectable under pressure from said source into said melt in said barrel.

10. A method of molding a powder based material comprising the steps of:
providing a powder material
providing a binding material
mixing said powder material and said binding material to form a feedstock material
transforming said feedstock material into a melt feedstock material
adding a pressurized gas into said melt feedstock material to form a melt porous feedstock material
introducing said melt porous feedstock material into a cavity mold to form a green porous part having the shape of the mold
removing said binding material, through the pores from said green porous part, in order to form a solid porous material.

11. A method of molding a powder based material comprising the steps of:
providing a feedstock material made of a powder material and a binding material
transforming said feedstock material into a melt feedstock material
adding a pressurized gas into said melt feedstock material to form a melt porous feedstock material
introducing said melt porous feedstock material into a cavity mold to form a green porous part having the shape of the mold
removing said binding material, through the pores from said green porous part, in order to form a solid porous material.

12. An apparatus for molding a powder based material comprising:
a device to mix a powder material and a binding material and to obtain a feedstock material
a device to turn said feedstock material into a melt feedstock material
a source of a pressurized gas
a device to introduce said pressurized gas into said melt feedstock material to form a melt porous feedstock material
a mold to receive said melt porous feedstock material to create a porous green part having the shape of the mold.

13. An apparatus for molding a powder based material comprising:
an injection molding machine to process a feedstock material made of a powder material and a binder material
a source of a pressurized gas
a device to introduce said pressurized gas into said melt feedstock material to form a melt porous feedstock material
an injection mold to receive said melt porous feedstock material to create a porous green part having the shape of the mold.

14. A green molded article made of a powder material, a binder and having pores, wherein said pores have been created during an injection molding process and wherein a gas has been added inside an injection molding barrel during the injection molding process to create said pores.
